(19) United States
(12) Patent Application Publication
(10) Pub. No.: US 2005/0081518 A1
(43) Pub. Date: Apr. 21, 2005

(54) Flow-control apparatus for controlling the swing speed of a boom assembly

(76) Inventors: Pengfei Ma, Lisle, IL (US); Anil Kumar R. Shenoy, Raleigh, NC (US)

Correspondence Address: CATERPILLAR INC.;100 N.E. ADAMS STREET, PATENT DEPT., PEORIA, IL, 616296490, US

(21) Appl. No.: 10/689,371

(22) Filed: Oct. 20, 2003

(51) Int. Cl. F16D 31/02

(52) U.S. Cl. 60/445

(57) ABSTRACT

A fluid flow-control apparatus for a swing system of a work machine. The system includes a source of variable pressurized fluid, directional flow device coupled to said source of pressurized fluid, said directional flow device having a directional flow member, a flow-compensation device coupled to said directional flow device, a fluid flow-biasing device coupled to said flow-compensation device, and a plurality of motors coupled to said directional flow device.

### TECHNICAL FIELD

This invention relates to the field of backhoes, and, more particularly, to an apparatus for controlling the swing speed of a backhoe boom.

### BACKGROUND

Backhoes serve a variety of functions, such as, digging ditches, loading work trucks, and laying pipe. In order to carry out these functions, the boom of the backhoe is capable of swinging from side-to-side by rotating the boom about a pivotal connection to the frame. A pair of hydraulic cylinders having one end connected to the boom and the other end connected to the frame of a work vehicle aide in rotating the boom by extending one cylinder while the other retracts.

Because of the mechanical linkage configuration of the cylinders connected to the frame and boom, the geometry of the linkage varies as the boom is swung. This in combination with constant flow of fluid results in pressure spikes in the swing system. Since the angular swing velocity is proportional to the swing system pressure, the angular swing velocity varies throughout the swing event. This is undesirable to the operator when trying to position the boom to perform a function, because the operator cannot precisely gaugein unaware when the boom is going to accelerate or decelerate.

In order to correct this problem, it is well known in the art to add backpressure to the swing system by restricting the fluid flow from the cylinders to the tank. The added backpressure blows the relief valve causing the variable displacement pump to destroke. Since in the swing operation backpressure is generally high, it can generate heat and has a potential of generating high flow force in the swing system.

One known swing speed control system is disclosed in U.S. Pat. No. 5,413,452, issued to Lech et al. on May 9, 1995. Lech discloses the use of a priority valve to direct and regulate priority flow of actuating fluid through a priority circuit to the hydraulics swing motors. The regulated flow is intended to allow the operator to achieve a constant swing speed.

The present invention is directed to overcoming one or more of the problems set forth above.

### SUMMARY OF THE INVENTION

In one embodiment, a fluid flow-control apparatus for a swing system of a work machine includes a source of variable pressurized fluid coupled to a directional flow device, having a directional control member, a flow-compensation device coupled to the directional flow device, a fluid flow-biasing device coupled to the flow-compensation device, and a plurality of motors coupled to the directional flow device.

A method for controlling the fluid flow in a swing system of a work vehicle is also disclosed. The swing system includes a fluid flow-control apparatus. The fluid flow-control apparatus includes a fluid flow-biasing device coupled to a flow-compensation device, the flow-compensation device coupled to a directional flow device, and the directional flow device includes a directional flow member. The method includes activating said swing system, controlling the fluid flow using a fluid flow-control apparatus.

### BRIEF DESCRIPTION OF THE DRAWINGS

FIG. 1 is a drawing of an embodiment of a work machine;

FIG. 2 is a schematic of an embodiment of a swing system of a work machine;

FIG. 3 is a diagrammatic view of a fluid flow-control apparatus; and

FIG. 4 is a schematic of another embodiment of a swing system of a work machine.

### DETAILED DESCRIPTION

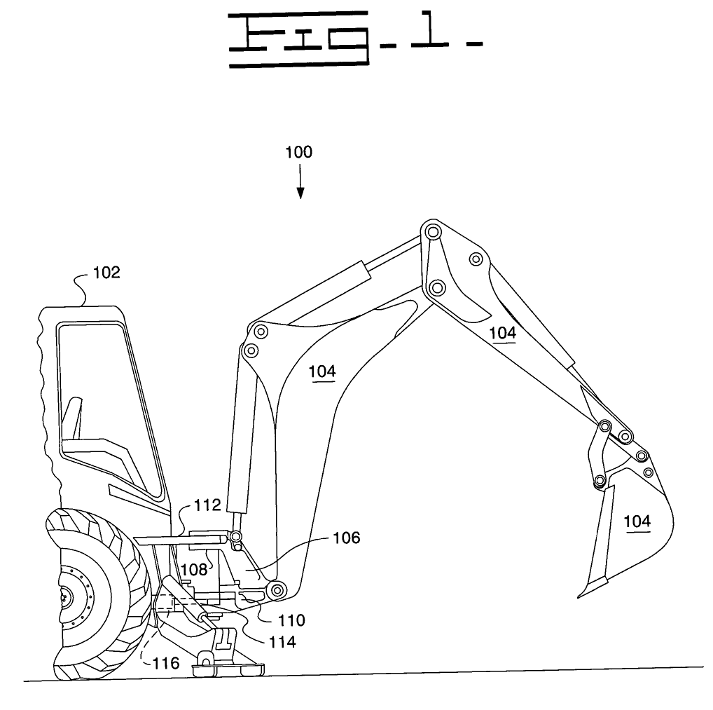

FIG. 1 depicts a work machine 100, illustrated in the embodiment shown as a vehicle 102 being attached with a swingable boom assembly 104. The boom assembly 104 is shown includes a boom, a stick attached to the boom, and a bucket attached to the stick, but not limited to single boom assemblies, multiple boom assemblies, forestry boom assemblies, dredging boom assemblies, or any like boom assemblies that are swingable. The boom assembly 104 is pivotably connected to a boom support bracket 106 by means known in the art. The boom support bracket 106, having an upper and lower pivotal portion 108,110, is pivotably connected to a upper and lower mounting frame 112,114 of the work machine 100, which allows the boom assembly 104 to rotate within a pre-determined range. A plurality of motors 116, in the embodiment shown as hydraulic cylinders, is located on opposing sides of the boom support bracket 110 and pivotably connected to the boom support bracket 110 and the lower frame 108.

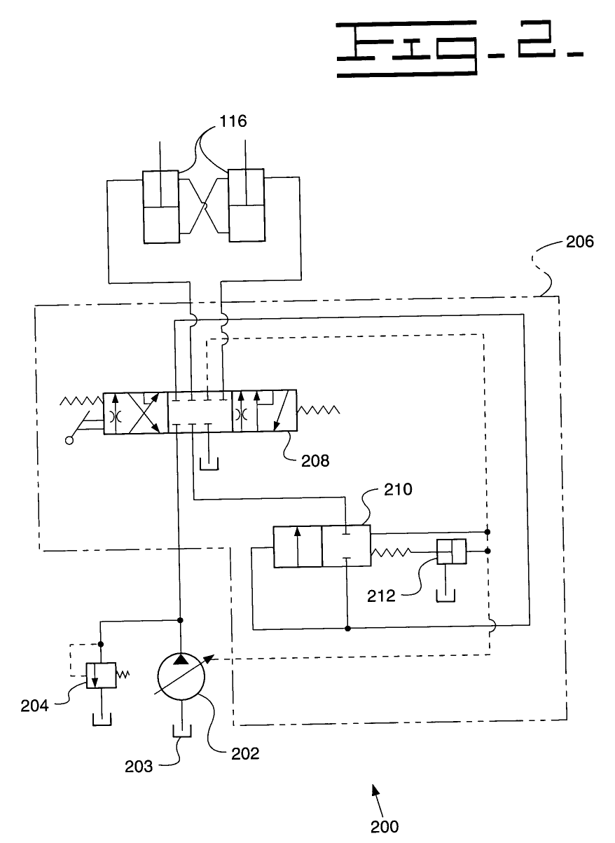

FIG. 2 is a schematic of a swing system 200 of the work machine 100. The swing system 200 includes a source of pressurized fluid 202, which in the embodiment shown is a pressure compensated variable displacement pump. Coupled to the source of pressurized fluid 202 is a reservoir of fluid 203. The swing system 200 may also include a pressure relief valve 204 for relieving excess pressure in a known manner.

A fluid flow-control apparatus 206 coupled to the source of pressurized fluid 202 includes a directional flow device 208, a flow-compensation device 210, and a fluid flow-biasing device 212. The directional flow device 208 in the embodiment shown is a closed-center, spring-centered, lever operated control valve, but alternatively could be a solenoid type, pressure compensated type, or any like valve. The source of pressurized fluid 202 is pressure compensated by fluid pressure inputted from the fluid flow-control apparatus 206 to vary the output fluid flow of the source of pressurized fluid. As illustrated in the embodiment, the plurality of motors 116 is coupled to the directional flow device 208.

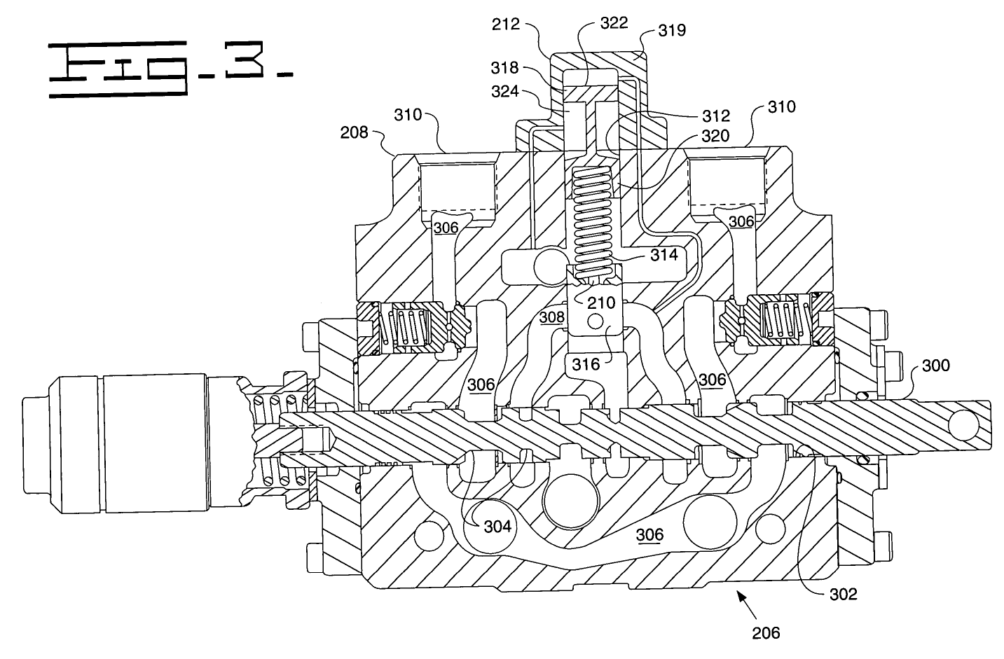

FIG. 3 is a diagrammatic view of the fluid flow-control apparatus 206. The directional flow device 208 includes a directional flow member 300, known in the art as a spool, slidably positioned within a bore 302 of the directional flow device 208. The directional flow member 300 has radial grooves 304 with pre-determined widths and depths. The radial grooves 304 are spaced at pre-determined locations along the axial length of the directional flow member 300. As the directional flow member 300 shifts, the radial grooves 304 are positioned to allow fluid to flow through a passage 306 of the directional flow device 208. One of these passages 306 is shown as a fluid bridge 308, which allows fluid to flow from the source of pressurized fluid 202 (FIG. 2) to a port 310.

The flow-compensation device 210 is coupled to the directional flow device 208. In the embodiment shown the flow-compensation device 210 is axially aligned with a bore 312 in the directional flow device 208. Alternatively, the flow-compensation device 210 could be coupled to the swing system 200 and placed in fluid communication with the swing system 200. The flow-compensation device 210 includes a biasing member 314 and a flow-metering member 316 coupled to the biasing member 314. For exemplary purposes, the flow-metering member 316 is in communication with the fluid bridge 308 and positionable to meter the fluid flow through the fluid bridge 308.

The fluid flow-biasing device 212 is coupled to the directional flow device 208. The fluid flow-biasing device 212 includes an actuator 318, which in the embodiment shown is a piston type, slidably coupled in a valve housing 319. Alternatively the actuator could be a diaphragm or the like. The actuator 318 axially aligns with the flow-compensation device 210. A rod end 320 of the actuator 318 connects with the biasing member 314 of the flow-compensation device 210. In the embodiment shown a head end 322 of the actuator 318 is in communication with the fluid bridge 308. Alternatively, the head end 322 could be in communication with the high-pressure side of the swing system 200. The cavity 324 formed intermediate the rod end 320 and head end 322 of the actuator 318 is in communication with the reservoir 203 (FIG. 2).

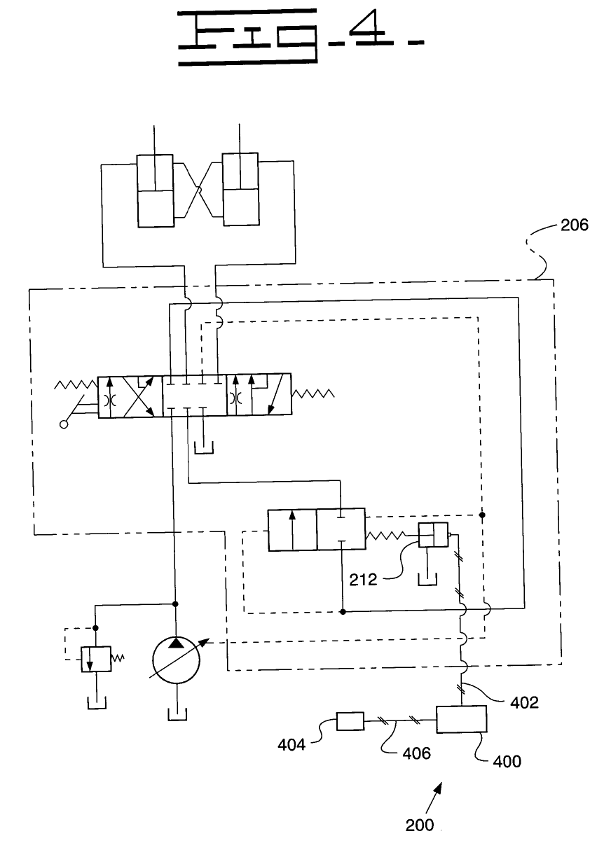

FIG. 4 depicts an alternative embodiment of the swing system 200. A control device 400, such as an electronic control module (ECM), is coupled to the fluid flow-control apparatus 206, and outputs a signal 402 indicative of inputted data to the fluid flow-biasing device 212. The fluid flow-biasing device 212 positions the flow-metering member 316 (FIG. 3) in the fluid bridge 308 (FIG. 3), thereby varying the flow of fluid. For exemplary purposes a sensor 404 is coupled to the control device 400, which inputs a signal 406 to the control device 400 indicative of a pre-determined parameter of the work vehicle 100 (FIG. 1). Though the embodiment shown has one sensor 404, multiple sensors 404 could input parameter data to the control device 400. For example, a swing angle sensor could output a signal 406 to the control device 400 indicative of the rotational angle of the boom 104. Another sensor could be a pressure detection device coupled to the fluid flow-control apparatus 206, which outputs a signal 406 indicative of the fluid pressure in the swing system 200.

Industrial Applicability

Upon a swing command from an operator, the source of pressurized fluid 202 provides fluid to the plurality of motors 116 attached to the boom support bracket 106, to which the boom assembly 104 is attached. The plurality of motors 116 extends and retracts respectively to swing the boom assembly 104 at a generally constant speed, within the pre-determined range.

In order to perform the aforementioned function, fluid from the source of pressurized fluid 202 is provided to the fluid flow-control apparatus 206. The axial shifting of the directional control member 300 positions the radial grooves 304 to direct the fluid from the source of pressurized fluid 202 into the fluid bridge 308. Upon sufficient fluid pressure acting on the flow-metering member 316 of the flow-compensation device 210, the biasing member 314 is compressed, thus positioning the flow-metering member 316 to allow fluid to flow through the fluid bridge 308. Fluid flow is then directed to the appropriate port 310 by the position of the radial grooves 304 of the directional control member 300 in the directional flow device 208. Fluid is then provided to the plurality of motors 116, wherein the extension and retraction of the plurality of motors 314 swings the boom assembly 104.

As swing system 200 fluid pressure increases and decreases during the swing operation, fluid from the fluid bridge 308 acts on the actuator 318 of the fluid flow-biasing device 212. An increase in swing system 200 fluid pressure generated by the swing geometry of the boom 104 increases the fluid pressure acting on the actuator 318, thereby extending the actuator 318. In turn, the flow-metering member 316 is repositioned to restrict the fluid flow through the fluid bridge 308. The restriction will increase the pressure drop across the fluid flow-control apparatus 206, thereby decreasing the output flow of fluid of the pressure compensated variable displacement pump, resulting in decreasing the angular swing velocity of the boom 104. As the swing geometry provides a decrease in swing system 200 fluid pressure, the actuator 318 retracts and repositions the flow-metering member 316 to decrease the pressure drop across the directional flow device 208. The decrease in the pressure drop increases the fluid flow of the pressure compensated variable displacement pump, thereby increasing the angular swing velocity of the boom 104. The oscillation of increasing and decreasing fluid flow of the pressure compensated variable displacement pump maintains a generally constant angular swing velocity of the boom assembly 104.

Alternatively, a control device 400 would control the position of the flow-metering member 316 in the fluid bridge 308. At least one sensor 404 outputs a signal 406 indicative of pre-determined work vehicle 100 parameter to the control device 400. The control device 400 would then output a signal 402 to the fluid flow-control apparatus 206 indicative of the pre-determined work vehicle 100 parameters. The fluid flow-control apparatus 206 would then position of the flow-metering member 316 to meter the fluid flow through the fluid bridge 308, thereby increasing or decreasing the pressure drop across the directional flow device 208. As disclosed hereinbefore, the pressure drop adjusts the pressure compensated variable displacement pump as to maintain a constant angular swing velocity of the boom assembly 104.

1. A fluid flow-control apparatus for a swing system of a work machine, comprising:
a source of variable pressurized fluid;
a directional flow device coupled to said source of pressurized fluid, said directional flow device having a directional flow member;
a flow-compensation device coupled to said directional flow device;
a fluid flow-biasing device coupled to said flow-compensation device; and
a plurality of motors coupled to said directional flow device.

2. The flow-control apparatus set forth in claim 1, wherein said fluid flow-biasing device includes an actuator.

3. The flow-control apparatus set forth in claim 2, wherein said flow-compensation device includes a flow-metering member coupled to said actuator, said flow-metering member being in communication with said fluid flow of said swing system.

4. The flow-control apparatus set forth in claim 3, wherein said flow-metering member is positionable to meter said fluid flow of said swing system.

5. The flow-control apparatus set forth in claim 3, wherein fluid pressure from said swing system is in communication with said actuator to position said flow-metering member.

6. The flow-control apparatus set forth in claim 4, including a control device coupled to said fluid flow-biasing device, said control device outputting a signal to said fluid flow-biasing device to position said flow-metering member.

7. The flow-control apparatus set forth in claim 6, including at least one sensor coupled to said control device, said sensor inputting a signal to said control device based on at least one pre-determined parameter.

8. The flow-control apparatus set forth in claim 7, wherein said at least one sensor is a load sensor.

9. The flow-control apparatus set forth in claim 7, wherein said at least one sensor is a swing angle sensor.

10. A method for controlling the fluid flow in a swing system of a work machine, said swing system includes a fluid flow-control apparatus, said fluid flow-control apparatus includes a fluid flow-biasing device coupled to a flow-compensation device, said flow-compensation device being coupled to a directional flow device, and said directional flow device including a directional flow member, comprising the steps of:
activating said swing system;
controlling said fluid flow using a fluid flow-control apparatus.

11. The method set forth in claim 10, including metering said fluid flow using a flow-metering member included in said flow-compensation device.

12. The method set forth in claim 11, including adjusting said flow-metering member using fluid pressure from said swing system in fluid communication with an actuator included in said fluid flow-biasing device, said fluid flow-biasing device being coupled to said flow-metering member.

13. The method set forth in claim 11, including inputting an output signal from a control device to said flow-compensation device, said control device being coupled to said flow-compensation device.

14. The method set forth in claim 13, including adjusting said flow-metering member using said signal from said control device.

15. The method set forth in claim 14, including inputting an input signal to said control device from at least one sensor, said signal being based on pre-determined parameters.
